(19) United States
(12) Patent Application Publication
(10) Pub. No.: US 2024/0026581 A1
(43) Pub. Date: Jan. 25, 2024

(54) PLASTIC NETTING IN THE FORM OF RASCHEL NETTING FOR THE CULTIVATION AND HARVEST OF ONIONS

(71) Applicant: KARATZIS S.A. INDUSTRIAL & HOTELIER ENTERPRISES, Heraklion/Kreta (GR)

(72) Inventor: Antonios KARATZIS, (GR)

(73) Assignee: KARATZIS S.A. INDUSTRIAL & HOTELIER ENTERPRISES, Heraklion/Kreta (GR)

(21) Appl. No.: 18/044,001

(22) PCT Filed: Jul. 27, 2021
(86) PCT No.: PCT/EP2021/071082

§ 371 Date: Mar. 3, 2023

(30) Foreign Application Priority Data
Oct. 29, 2020 (DE) 10 2020 128 480.2

(51) Int. Cl. D04B 21/12; D04B 21/16; A01G 13/02; A01D 25/00

(52) U.S. Cl. CPC D04B 21/12; D04B 21/16; A01G 13/0268; A01D 25/00; D10B 2505/00; D10B 2321/02; D10B 2401/061; D10B 2401/063; A01G 22/35

(57) ABSTRACT

A plastic netting in the form of a raschel netting (2) for the cultivation and harvest of onions. The plastic netting has a plurality of pillar stitches (1) extending mutually in parallel in the longitudinal direction. These pillar stitches are transversely interlinked by traversing weft threads (4). Each pillar stitch (1) being formed by at least two threads (2, 3).

This application is a National Stage completion of PCT/EP2021/071082 filed Jul. 27, 2021, which claims priority from German patent application serial no. 10 2020 128 480.2 filed Oct. 29, 2020.

### FIELD OF THE INVENTION

The invention relates to a plastic net, embodied as a raschel net, for the cultivation and the harvest of onions according to the independent claim(s).

### BACKGROUND OF THE INVENTION

Plastic nets or respectively plastic nets embodied as raschel nets are known from the prior art. They are knitted from a plastic thread by means of raschel machines, wherein substantially over the entire width of the machine plastic threads are intertwined to threads by means of needles.

For the cultivation or respectively for the planting and for the harvest of onions, plastic nets, embodied as raschel nets, are often used; here, the seed is situated in the earth between an upper and a lower net, wherein for harvest both nets are raised, so that the earth falls down through the meshes of the lower net and the onions remain between the two nets.

By means of raschel machines, very light nets can be produced in an advantageous manner. Here, the raschel nets on the one hand are to have as low a weight as possible through the use of thin, and therefore light, plastic threads; on the other hand, the raschel nets are to have as high a strength as possible, so as not to be damaged during harvesting of the onions due to the weight of the onions and the corresponding pressure, whereby the onions fall down.

The known raschel nets for the cultivation and for the harvest of onions have chains, also designated as fringes, which are produced respectively by the intertwining of a thread, wherein the chains are connected respectively transversely by weft threads running to and fro, whereby the entire raschel net is formed. The threads of the fringes have a width which amounts to 4-5 mm before the processing by the raschel machine; the weight of the known raschel nets for the cultivation and the harvest of onions amounts to ca. 21 gr/m2-22 gr/m2.

### SUMMARY OF THE INVENTION

The present invention is based on the problem of indicating a plastic net, embodied as a raschel net, for the cultivation and the harvest of onions with a low weight in relation to its dimensioning and with a high strength.

This problem is solved by the features of the independent claim(s). Further configurations and advantages according to the invention will emerge from the subclaims.

Accordingly, a plastic net, embodied as a raschel net, for the cultivation and the harvest of onions is proposed, which has a plurality of fringes, extending parallel to one another in longitudinal direction, formed respectively of at least two threads, which are connected transversely through weft threads running to and fro.

The fringes of the plastic net according to the invention for the cultivation and the harvest of onions are knitted respectively from at least two threads; each individual fringe is produced by the intertwining of at least two threads.

Preferably, the fringes of the plastic net according to the invention are formed from respectively two or three threads, however configurations having several threads per fringe are possible.

According to the invention, the threads are embodied as thin bands and have width which amounts to 1.25-3 mm before the processing by means of a raschel machine, wherein the thickness of the threads amounts to 70-75 μm. During the processing, the threads are stretched or respectively pre-stretched.

According to a preferred configuration of the invention, the distance between two fringes amounts % inch; within the scope of further configurations, further values are possible for the distance between two fringes.

In this way, a plastic net, embodied as a raschel net, for the cultivation and the harvest of onions is created, the fringes of which, which are formed from two or more threads, have a breaking strength which exceeds 90 kp, wherein the residual elasticity of the fringes lies in a range between 17% and 19%±5%.

The weight of a plastic net according to the invention, for the case where the fringes (1) are formed respectively from two threads and the distance between two fringes amounts to ½ inch, is 16.5 gr/m2-18.5 gr/m2, wherein according to measurements in accordance with the ISO 2062 standard, the width of the threads of the fringes after the production of the raschel net amounts to 0.75 mm-1.25 mm. When the fringes are formed respectively from more than two threads, the weight of the plastic net is increased accordingly, is however significantly lower than the weight of the raschel nets, known from the prior art, for the cultivation and the harvest of onions.

The plastic net, embodied as a raschel net, according to the invention, for the cultivation and the harvest of onions has accordingly in an advantageous manner a significantly lower weight per square metre than the known raschel nets for the cultivation and the harvest of onions, with a higher breaking strength than the known raschel nets for the cultivation and the harvest of onions.

Thereby, the environmental impact by plastics is reduced, wherein the price, owing to the low weight per square metre, is generally lower than the price of nets produced according to the prior art. In addition, the harvest is optimized, because a damage to the net, as occurs in the nets known from the prior art, is largely ruled out.

The entire width of the plastic net according to the invention can be as desired. For example, the width of the plastic net can lie in a range between 105 and 300 centimetres.

The threads from which the fringes of the plastic net are formed can be produced from polyolefins such as for example LLDPE (linear polyethylene with low density), LDPE (polyethylene with low density), HDPE (polyethylene with high density), PVC (polyvinyl chloride), EVA (ethylene vinyl acetate) or from a similar plastic or can comprise the latter.

### BRIEF DESCRIPTION OF THE DRAWINGS

The invention is explained more closely in the following with the aid of the attached figures. The general construction of raschel nets and the construction and the mode of operation of raschel machines are very well known to the specialist in the art, so that in the following the features are described which are of significance for the present invention. There are shown:

FIG. 1: A schematic view of a fringe of the net according to the invention for the cultivation and for the harvest of onions;

FIG. 2: A schematic view of two fringes of the net according to the invention for the cultivation and for the harvest of onions and of the weft threads connecting these fringes with adjacent fringes; and

FIG. 3: A schematic view of parts of a net according to the invention and of relevant components of a raschel machine.

### DETAILED DESCRIPTION OF THE PREFERRED EMBODIMENTS

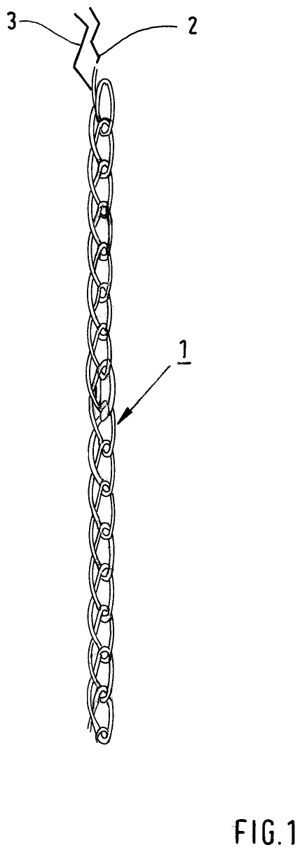

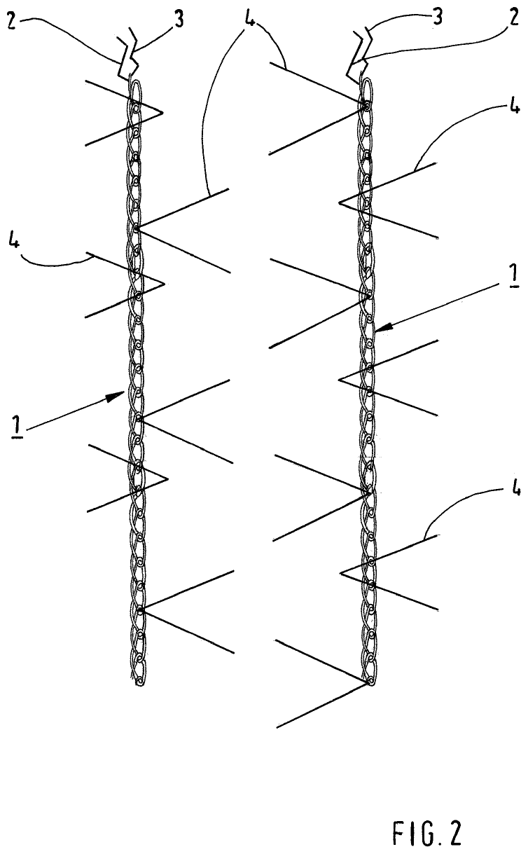

According to the invention and with respect to the attached FIG. 1, the fringes 1 of a plastic net, embodied as a raschel net, for the cultivation and for the harvest of onions are formed from at least two threads; in the example shown in FIG. 1, the fringes 1 are formed respectively from two threads 2, 3. The fringes 1 are connected by weft threads with a zigzag interweaving to a net. This is illustrated with the aid of FIG. 2, wherein the weft threads are given reference number 4.

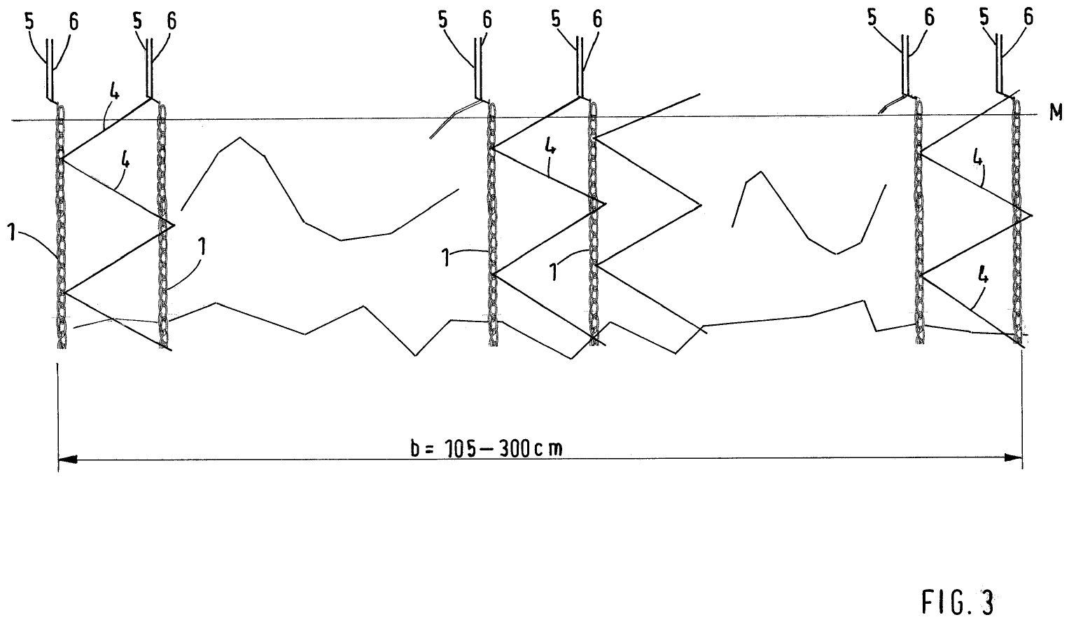

FIG. 3 shows only sections from the entire plastic net; the regions lying therebetween have fringes and weft threads. For the production respectively of a fringe 1, an individual guide needle 5 is provided, through which the at least two threads from which the fringe 1 is formed are guided, which cooperates with an individual guide needle 6, through which a weft thread is guided.

The needles 5, 6 are arranged around the machine plane M, wherein the machine plane M is the region in which the needles 5, 6 interact in order to produce a raschel net. Preferably, the width b of a plastic net embodied according to the invention for the cultivation and for the harvest of onions lies in range between 105 and 300 centimetres.

1-8. (canceled)

10. A plastic net, embodied as a raschel net, for cultivation and harvest of onions, the plastic net comprising a plurality of fringes (1) extending in a longitudinal direction parallel to one another and being connected transversely by weft threads (4) running to and fro,
wherein the fringes (1) are formed respectively from at least two threads (2, 3), the at least two threads (2, 3) are embodied as bands and, before processing by means of a raschel machine, the at least two threads (2, 3) have a width which amounts to 1.25-3 mm (0.049-0.118 inches), and
a thickness of the threads (2, 3), before the processing, amounts to 70-75 mm (2.7559-2.9528 inches).

11. The plastic net, embodied as a raschel net, according to claim 10, wherein the threads (2, 3), from which the fringes (1) are formed, are produced from polyolefins comprise polyolefins.

12. The plastic net, embodied as a raschel net, according to claim 10, wherein the threads (2, 3), from which the fringes (1) are formed, are produced from one of LLDPE (linear polyethylene with low density), LDPE (polyethylene with low density), HDPE (polyethylene with high density), PVC (polyvinylchloride), EVA (ethylene vinyl acetate) or comprise LLDPE, LDPE, HDPE, PVC or EVA.

13. The plastic net, embodied as a raschel net, according to claim 10, wherein the fringes (1) are respectively formed from two or three threads (2, 3).

14. The plastic net, embodied as a raschel net, according to claim 10, wherein the distance between two fringes (1) amounts to 1.27 cm (0.5000 inches).

15. The plastic net, embodied as a raschel net, according to claim 14, wherein in a case where the fringes (1) are respectively formed from two threads, a weight of the plastic net amounts to 16.5 gr/m²-18.5 gr/m² (0.00338-0.00379 lbs/ft²), and a width of the threads, after the production of the raschel net, amounts to 0.75 mm (0.0295 inches)-1.25 mm (0.0492 inches).

16. The plastic net, embodied as a raschel net, according to claim 10, wherein that the residual elasticity of the fringes (1) lies in a range of between 17% and 19%±5%.

17. The plastic net, embodied as a raschel net, according to claim 10, wherein the fringes (1) have a breaking strength which exceeds 90 kp (198.414 lbf).
